(19) United States
(12) Patent Application Publication
(10) Pub. No.: US 2024/0318047 A1
(43) Pub. Date: Sep. 26, 2024

(54) HOT MELT ADHESIVE COMPOSITION WHICH FEELS SOFT IN A LAMINATE, METHODS FOR USING THE SAME, AND ARTICLES MADE THEREWITH

(71) Applicant: BOSTIK S.A., Colombes (FR)

(72) Inventors: Richard E. HAMANN, Wauwatosa, WI (US); Kun WANG, Shanghai (CN); Danfeng LI, Shanghai (CN); Wu YONG, Shanghai (CN)

(21) Appl. No.: 18/278,205

(22) PCT Filed: Feb. 24, 2022
(86) PCT No.: PCT/US2022/017672

§ 371 Date: Aug. 22, 2023

(30) Foreign Application Priority Data
Feb. 24, 2021 (CN) 202110207943.1

(51) Int. Cl. C09J 7/35; C09J 11/08; C09J 123/14

(52) U.S. Cl. CPC C09J 7/35; C09J 11/08; C09J 123/14; C09J 2301/304; C09J 2301/312; C09J 2301/408; C09J 2301/50; C09J 2400/263

(57) ABSTRACT

A hot melt adhesive composition comprises a combination of polymers including a low molecular weight semicrystalline propylene based polymer and a high molecular weight essentially amorphous propylene based polymer, both of which are prepared by using single-site catalysts, along with a wax, a hydrogenated styrene block copolymer, a tackifier, and a plasticizer. The composition has suitable viscosity ranging from 500 cP to 40,000 cP at 177° C. and is useful for a variety of industrial applications where bonding of low surface energy substrates and elastic substrates is encountered, including disposable nonwoven hygienic articles. The cooled adhesive in the laminate does not feel hard but instead has a soft feel, even though the adhesive demonstrates a relatively high Shore A hardness.

### FIELD OF THE INVENTION

This invention relates to a novel hot melt adhesive composition based on a polymer blend comprising polypropylene polymers prepared by using single-site catalysts and which feels soft in a laminate. The adhesive composition is particularly useful in bonding elastic substrates and low surface energy substrates that are often seen in manufacturing a variety of disposable nonwovens hygienic products, such as baby diapers, adult incontinent articles, and feminine hygiene pads.

### BACKGROUND OF THE INVENTION

Hot melt adhesives typically exist as a solid mass at ambient temperature and can be converted to a flowable liquid by the application of heat. These adhesives are particularly useful in manufacturing a variety of disposable goods in which bonding of various substrates is often necessary. Specific applications include disposable diapers, hospital pads, feminine sanitary napkins, panty shields, surgical drapes and adult incontinent briefs, collectively known as disposable nonwoven hygienic products. Other diversified applications have involved paper products, packaging materials, automotive headliners, appliances, tapes and labels. In most of these applications, the hot melt adhesive is heated to its molten state and then applied to a substrate, often named as the primary substrate. A second substrate, often named as the secondary substrate, is then immediately brought into contact with and compressed against the first. The adhesive solidifies on cooling to form a strong bond. The major advantage of hot melt adhesives is the absence of a liquid carrier, as would be the case of waterborne or solvent-based adhesives, thereby eliminating the costly process associated with solvent removal.

For many applications, hot melt adhesives are often extruded directly onto a substrate in the form of a thin film or a bead by using piston or gear pump equipment. In this case, the substrate is brought into intimate contact with a hot die under pressure. The temperature of the die must be maintained well above the melting point of the adhesive to allow the molten hot melt material to flow through the application nozzle smoothly. For most applications, particularly those encountered in food packaging and disposable nonwovens hygienic article manufacturing, bonding of delicate and heat sensitive substrates, such as thin gauge plastic films, is often involved. This imposes an upper limit on coating temperature for hot melt adhesive applications. Today's commercial hot melts are typically formulated to have coating temperature below 200° C., preferably below 150° C., to avoid substrate burning or distortion. Besides directly coating, several indirect or noncontact coating methods, through which a hot melt adhesive can be spray-coated with the aid of compressed air onto a substrate from a distance, are also developed. These non-contact coating techniques include conventional spiral spray, Omega™, Surewrap™ and various forms of melt-blown methods. In many cases, the indirect method, however, requires that the viscosity of the adhesives must be sufficiently low, usually in the range of 2,000 to 30,000 cP, preferably in the range of 2,000 to 15,000 cP, at the application temperature in order to obtain an acceptable coating pattern. Many other physical factors, especially the rheological properties of the adhesive, come into play in determining the sprayability of a hot melt. The majority of commercial hot melt products do not lend themselves to spray applications. There are no accepted theoretical models or guidelines to predict sprayability, which must be determined empirically with application equipment.

Hot melt adhesives are organic materials typically consisting of a polymer, a plasticizer, a tackifying resin, and an antioxidant package. Other ingredients, such as wax, filler, colorant and UV absorber, can also be used to modify the adhesive properties or to provide special attributes. These organic ingredients are prone to heat degradation under the coating conditions of the adhesive. For example, the widely used commercial hot melt adhesive based on styrene-isoprene-styrene (SIS) triblock copolymer, when subjected to 175° C. for 24 hours, can suffer from a viscosity drop of about 50 percent from its original value. A styrene-butadiene-styrene (SBS) based hot melt may cause problems by crosslinking under similar conditions. Crosslinking can result in a dramatic increase in viscosity and may eventually render the adhesive un-flowable by the formation of three dimensional polymer network. The viscosity change is often accompanied by charring, gelling, and formation of skin on top of the molten material. The degradation will inevitably lead to deterioration of the adhesive properties and performance. In addition, they can also cause equipment damage. The rate of degradation is temperature dependent; the higher the temperature, the faster the degradation. Thus, reducing the coating temperature of the adhesive can slow down degradation.

U.S. Pat. No. 10,011,744 describes a hot melt adhesive comprising a low molecular weight semicrystalline propylene-based polymer and a high molecular weight essentially amorphous propylene-based polymer, a tackifier, and a plasticizer. Adhesives according to this patent have been found to provide a unique combination of properties which previous hot melt adhesives had failed to offer, including providing a high bond strength to a variety of low surface energy substrates, high cohesive strength to hold elastic materials under constant tension, excellent heat stability, good wet-out properties, a broad application temperature range, a long open time, good green bond strength, and suitability with essentially all known hot melt coating methods. However, certain adhesive formulations disclosed in this patent have a hard hand-feel after cooling in the laminate.

### SUMMARY OF THE INVENTION

Therefore, it would be advantageous to provide a hot melt adhesive that will overcome the shortcomings of the prior art adhesives mentioned above. It is found in the present invention that a polyolefin polymer blend comprising a semicrystalline low molecular weight, single site catalyst polypropylene-based (LMW SSC-PP) polymer and an essentially amorphous high molecular weight, single site catalyst polypropylene-based (HMW SSC-PP) polymer, along with a wax and a hydrogenated styrene block copolymer provides an adhesive which, when cooled and in the laminate form, feels soft. The adhesive still provides the unique combination of properties provided by the '744 patent, including providing a high bond strength to a variety of low surface energy substrates, a high cohesive strength to hold elastic materials under constant tension, excellent heat stability, good wet-out properties, a broad application temperature range, a long open time, good green bond strength, and suitability with essentially all known hot melt coating methods.

In accordance with an embodiment of the present invention, a hot melt adhesive composition comprises a first polymer comprising a single-site catalyzed polypropylene co-polymer having a weight average molecular weight from about 10,000 g/mole to about 90,000 g/mole and a melt enthalpy of about 30 J/g to about 100 J/g; a second polymer comprising a single-site catalyzed polypropylene co-polymer having a weight average molecular weight greater than 100,000 g/mole and a melt enthalpy of about 0 J/g to about 30 J/g; a wax; a hydrogenated styrene block copolymer; a tackifier; and a plasticizer.

In accordance with another embodiment of the invention, a method of making a laminate comprises the steps of applying the hot melt adhesive composition of any embodiment of the invention in a molten state to a primary substrate and mating a secondary substrate to the first substrate by contacting the secondary substrate with the adhesive composition, wherein at least one of the first substrate or the second substrate is elastic. The adhesive, upon cooling, bonds the first substrate and the second substrate together. Embodiments of the current invention also include a laminate made by a method according to embodiments of the invention. Such laminates may include an elastic leg cuff, a standing leg cuff, an elastic side panel, or a stretch ear for use in a disposable article.

### DETAILED DESCRIPTION OF THE INVENTION

As used herein, SSC refers to single-site catalysts for α-olefin polymerization.

As used herein, Mw refers to weight average molecular weight of a polymer. Unless specifically noted otherwise, weight average molecular weight is characterized herein using a high temperature Size Exclusion Chromatograph (SEC) using a polystyrene reference standard.

For the purposes of the present invention, the term essentially amorphous is used to refer to a state wherein a polypropylene-based polymer exhibits an enthalpy of melting from 0 J/g to about 30 J/g.

For the purposes of the present invention, the term semicrystalline is used to refer to a state wherein a polypropylene-based polymer exhibits an enthalpy of melting above 30 J/g.

As used herein, HMW SSC-PP refers to a class of high molecular weight essentially amorphous propylene homopolymers or copolymers produced by using single-site catalysts having a Mw greater than about 100,000 g/mole. The polymers can be completely amorphous showing no melting peaks on a DSC curve, but they can also have a small fraction of crystals that give rise on a DSC curve to a small, but noticeable, melting peak or peaks with associated enthalpy of melting of 30 joules per gram of material (J/g), or less, i.e. from 0 J/g to about 30 J/g.

As used herein, DSC curve refers to a plot of heat flow or heat capacity versus temperature obtained by using differential scanning calorimetry (DSC) instrument. The test method used to determine melt enthalpy is ASTM E793-01 “Standard Test Method for Enthalpies of Fusion and Crystallization by Differential Scanning Calorimetry,” as described in more detail in the Examples below.

As used herein, LMW SSC-PP refers to a class of low molecular weight semicrystalline propylene homopolymers or copolymers having a weight average molecular weight (Mw) of about 100,000 g/mole or less, and a distinct melting peak or peaks on a DSC curve with associated enthalpy of melting of 30 joules per gram of material (J/g) or greater, i.e. typically from about 30 J/g to about 100 J/g, more preferably from about 30 J/g to about 90 J/g, and most preferably about 35 J/g to about 80 J/g. The terms “enthalpy of melting”, “enthalpy of fusion”, “heat of fusion” and “heat of melting” are used interchangeably.

In accordance with the present invention, a hot melt adhesive composition is produced, comprising as the base polymer components a first polymer comprising a single-site catalyzed polypropylene co-polymer having a weight average molecular weight from about 10,000 g/mole to about 90,000 g/mole and a melt enthalpy of about 30 J/g to about 100 J/g and a second polymer comprising a single-site catalyzed polypropylene co-polymer having a weight average molecular weight greater than 100,000 g/mole and a melt enthalpy of about 0 J/g to about 30 J/g. Thus, the first polymer is a LMW SSC-PP and the second polymer is a HMW SSC-PP. Both polymers are prepared by using single-site catalyst systems, which can be distinguished from conventional Ziegler-Natta catalyst systems in several ways. Ziegler-Natta catalyst systems typically consist of a pair of catalyst and co-catalyst and the most common of such pairs are TiCl₃ and Al(C₂H₅)₂Cl, or TiCl₄ with Al(C₂H₅)₃. Conventional Z-N catalyst systems are typically embedded in an inert support and have several active catalyst sites on a support particle, each of which has different activity. In homopolymerization of α-olefins, the more active sites incorporate more monomer molecules into the polymer backbone, thereby producing polymer molecules having relatively longer chain lengths or higher molecular weight. Conversely, the less active sites will give rise to polymer molecules of shorter chain lengths. The polymers produced by Z-N catalyst will have very broad molecular weight distribution with a poly dispersity index (PDI) up to 10, whereas the polymers prepared by SSC catalysts have narrow molecular weight distribution with a PDI typically from about 1 (or 1.1) to about 4. The PDI is defined as the ratio of weight average molecular weight (Mw)/number average molecular weight (Mn). With Z-N catalysts, the polymerization reaction is highly stereospecific. The α-olefin molecules add to the polymer chain only in a particular orientation, depending on the chemical and crystal structure of the catalyst, thereby producing a regular, repeating three-dimensional polymer chain configuration.

Single-site catalyst systems (SSC) differ from the conventional Z-N catalysts in at least one significant way. They have only a single active transition metal site for each catalyst molecule and the activity at this metal site is therefore identical for all the catalyst molecules. One type of SSC catalyst that has now been widely used on industrial scale is a metallocene catalyst system consisting of a catalyst and a co-catalyst or activator. The catalyst is a transition metal complex having a metal atom situated between two cyclic organic ligands; the ligands being the same or different derivatives of cyclopentadiene. The co-catalyst can be any compound capable of activating the metallocene catalyst by converting a metallocene complex to a catalytically active species and an example of such compound is alumoxane preferably methylalumoxane having an average degree of oligomerization of from 4-30. For the purpose of this invention, other neutral or ionic activators can be used, including, but not limited to, various organic boron compounds such as tri(n-butyl)ammonium tetrakis(pentafluorophenyl borate, dimethylanilinium tetrakis(pentafluorophenyl borate or trityl tetrakis(pentafluorophenyl borate. Another type of SSC catalyst is the constrained geometry catalyst (CGC).

As used herein, CGC refers to a sub-class of SSC catalyst system known as constrained geometry catalyst. Different from metallocenes, the constrained geometry catalyst (CGC) is characterized by having only one cyclic ligand linked to one of the other ligands on the same metal center in such a way that the angle at this metal between the centroid of the pi-system and the additional ligand is smaller than in comparable unbridged complexes. More specifically, the term CGC is used for ansa-bridged cyclopentadienyl amido complexes, though the definition goes far beyond this class of compounds. Hence, the term CGC is broadly used to refer to other more or less related ligand systems that may or may not be isolobal and/or isoelectronic with the ansa-bridged cyclopentadienyl amido ligand system. Furthermore, the term is frequently used for related complexes with long ansa-bridges that induce no strain.

Like metallocenes, suitable CGCs may be activated methylaluminoxane (MAO), perfluorinated boranes and trityl borates co-catalysts. The catalytic systems based on CGCs, however, display incorporation of higher alpha-olefins to a much larger extend than comparable metallocene based systems. Non-metallocene based SSCs, also referred to as post-metallocene, single-site catalysts for olefin polymerization are also known. Typical post-metallocene catalysts feature bulky, neutral, alpha-diimine ligands. These post-metallocene catalysts, however, are more frequently used for polymerization of ethylene to produce plastomers and elastomers. They are rarely used for polymerization of α-olefins such as propylene. Single-site catalyst systems for olefin polymerization are well known to those skilled in the art and are extensively discussed in two symposia entitled Stereoselective Polymerization with Single-Site Catalysts edited by Lisa S. Baugh and Jo Ann M. Canich published by CRC press (2008), and Polyolefins: 50 Years after Ziegler and Natta II. Polyolefins by Metallocenes and Other Single-Site Catalysts edited by Walter Kaminsky and published by Springer Heidelberg (2013).

The composition of the present invention may comprise the first polymer and the second polymer in weight ratios from about 9:1 to about 1:9, preferably from about 7:1 to about 2:3, and most preferably from about 5:1 to about 3:1. When multiple ranges of constituents or properties are provided herein, the invention contemplates additional ranges extending between any of the limits of the ranges. For example, the weight ratio of the first polymer to second polymer may also extend from about 9:1 to about 2:3 and about 7:1 to about 3:1. The total amount of polymer in the composition of the present invention may vary over a wide range, for example from about 20% to about 80% by weight, preferably from about 25% to about 60% by weight, and most preferably from about 30% to about 45% by weight.

The first polymer in the hot melt adhesive composition of the present invention comprises either a homopolymer or a copolymer of propylene with at least one comonomer selected from the group consisting of ethylene and an alpha-olefin having a 4 to 8 carbon chain length, having from about 70% by weight to about 99% by weight, preferably having from about 80% by weight to about 98% by weight, and most preferably from about 85% by weight to about 98% by weight of propylene. The first polymer has a weight average molecular weight from about 10,000 g/mole to about 100,000 g/mole, preferably from about 10,000 g/mole to about 80,000 g/mole and most preferably from about 10,000 g/mole to about 60,000 g/mole, a melting point as measured by using DSC from about 20° C. to about 150° C., preferably from about 30° C. to about 110° C. and most preferably from about 40° C. to about 100° C., and having an enthalpy of melting as measured by using DSC from about 30 J/g to about 100 J/g, preferably from about 35 J/g to about 80 J/g and most preferably from about 35 J/g to about 60 J/g. These enthalpies of melting correspond to a degree of crystallinity, as calculated from the enthalpy of melting using 190 J/g for 100% crystalline isotactic PP, from about 18% to about 53% by weight, preferably from about 18% by weight to about 42% by weight, and most preferably from about 18% by weight to about 32% by weight. Further, the first polymer has a Brookfield viscosity at 190° C. ranging preferably from about 800 cP to about 100,000 cP and most preferably from about 1,000 cP to about 20,000 cP. In some embodiments, the first polymer has a weight average molecular weight from about 10,000 g/mole to about 30,000 g/mole, preferably from about 12,000 g/mole to about 29,000 g/mole and most preferably from about 15,000 g/mole to about 27,500 g/mole. Exemplary first polymers according to the present invention include Vistamaxx 8880, commercially available from Exxonmobil Chemical Company.

The second polymer in the hot melt composition of the present invention is either a propylene homopolymer or propylene based copolymer with at least one comonomer selected from the group consisting of ethylene and an alpha-olefin having a 4 to 8 carbon chain length, having from about 70% by weight to about 99% by weight, preferably having from about 80% by weight to about 98% by weight, and most preferably from about 80% by weight to about 90% by weight of propylene. The second polymer has a weight average molecular weight higher than 100,000 g/mole, preferably from about 100,000 g/mole to about 1,000,000 g/mole and most preferably from about 100,000 g/mole to about 600,000 g/mole. Further, the second polymer is a predominantly amorphous material with either no DSC melting peak or having small residual crystallinity, exhibiting a DSC melting peak from about 20° C. to about 120° C., preferably from about 30° C. to about 100° C. and most preferably from about 40° C. to about 80° C., and having an enthalpy of melting as measured by using DSC from about 0 J/g to about 30 J/g, preferably from about 5 J/g to about 25 J/g and most preferably from about 5 J/g to about 20 J/g. These enthalpies of melting correspond to a degree of crystallinity, as calculated from the enthalpy of melting using 190 J/g for 100% crystalline isotactic PP, from about 0% to about 18% by weight, preferably from about 2.6% by weight to about 15.8% by weight, and most preferably from about 2.6% by weight to about 13.2% by weight. The second polymer has a melt flow rate (MFR) per ASTM D 1238 at 230° C./2.16 Kg test conditions of from about 1 g/10 min to about 200 g/10 min, preferably from about 10 g/10 min to about 100 g/10 min and most preferably from about 20 g/10 min to about 60 g/10 min. Exemplary second polymers according to the present invention include Vistamaxx 6502, commercially available from Exxonmobil Chemical Company.

According to an embodiment of the invention, the molecular weight (M_{w}) of the second polymer is at least double the molecular weight of the first polymer. Preferably, the molecular weight of the second polymer is at least three times greater than the molecular weight of the first polymer. More preferably, the molecular weight of the second polymer is at least five times greater than the molecular weight of the first polymer. The molecular weight of the second polymer may be even at least eight or ten times greater than the molecular weight of the first polymer. By utilizing two polymeric constituents with such molecular weight offsets with respect to any adhesive disclosed herein, it has been found that the purposes of the invention can be more easily achieved. In another embodiment, the melt enthalpy of the first polymer is at least 20 J/g, preferably at least 35 J/g, and most preferably at least 50 J/g greater than the melt enthalpy of the second polymer.

The hot melt adhesive composition of the present invention also comprises a wax. Preferably, the wax comprises a Fischer-Tropsch wax. Synthetic Fischer-Tropsch waxes are obtained by the Fischer-Tropsch synthesis and include hydrocarbons originating from the Cobalt- or Iron-catalyzed Fischer-Tropsch synthesis of syngas (CO and H₂) to alkanes. The crude product of this synthesis is separated into liquid and different solid fractions by distillation. The hydrocarbons contain predominantly n-alkanes, a low number of branched alkanes, and basically no cyclo-alkanes or impurities. Fischer-Tropsch waxes consist of methylene units and their carbon chain length distribution is according to one embodiment characterized by an evenly increasing and decreasing number of molecules for the particular carbon atom chain lengths involved.

Fischer-Tropsch waxes preferably have a content of branched hydrocarbons between 10 and 25 wt. %. The branched molecules of the Fischer-Tropsch wax preferably contain more than 10 wt. %, most preferably more than 25 wt. %, molecules with methyl branches. Furthermore, the branched molecules of the Fischer-Tropsch wax preferably contain no quaternary carbon atoms.

In preferred embodiments of the invention, the hydrocarbon wax has a molecular mass (number average) between 500 and 1200 grams per mole, more preferred between 575 and 950 grams per mole. The molecular mass (number average) and the iso-alkane content of the hydrocarbon waxes is provided according to using gas chromatography according to EWF Method 001/03 of the European Wax Federation. In preferred embodiments the hydrocarbon wax additionally has independent of each other one or more of the following properties:
a Brookfield viscosity at 135° C. of below 20 mPa-s;
a penetration at 25° C. of below 10 1/10 mm, and preferably below 8 1/10 mm;
the hydrocarbon wax is hydrotreated; and
an oil content below 1 wt.-%.
   The value of the needle penetration at 25° C. is provided according to ASTM D 1321, and the oil content of the wax is provided according to ASTM D 721.

In embodiments of the invention, the waxes have one or more of the following properties:
A congealing point in accordance with ASTM D938 between about 60 and about 105° C., preferably between about 64° C. and about 102° C., more preferably between about 80° C. and about 102° C., and most preferably between about 80° C. and 86° C.;
A percentage of isoalkanes between about 2.5% and 20%, preferably between about 5 and 15%, most preferably between about 10% and 15%; and
A heat of fusion provided in accordance with ASTM E 793 between about 180 J/g and 230 J/g, preferably between about 205 J/g and about 230 J/g, most preferably between about 215 J/g and about 225 J/g.

Preferred waxes used herein are the SERATION line of Fischer-Tropsch waxes, especially SERATION 1830, commercially available from Sasol Ltd.

The hot melt adhesive composition of the present invention also comprises a hydrogenated styrene block copolymer (SBC). The hydrogenated SBC may be selected from the group comprising styrene-ethylene-butylene-styrene (SEBS), styrene-ethylene-butylene (SEB), styrene-ethylene-propylene-styrene (SEPS), styrene-ethylene-propylene (SEP) and styrene-ethylene-ethylene-propylene-styrene (SEEPS). Preferably, the hydrogenated styrenic block copolymer comprises or is an SEBS, SEPS, or SEEPS polymer. Most preferably, the hydrogenated styrenic block copolymer comprises or is SEBS. In an embodiment, the SEBS has from about 50 to about 85%, preferably from about 60 to about 80%, diblock content; has from about 15 to about 50%, preferably from about 20 to about 40%, styrene content; has a melt flow rate of from about 1 to about 100, preferably from about 20 to about 90, more preferably from about 40 to about 80 g/10 min. tested at 200° C. using a 5 kg weight; and has a Shore A hardness of from about 40 to about 100, preferably from about 50 to about 90, and most preferably from about 55 to about 85. One suitable SBC polymer for use in the invention is commercially sold under the trademark KRATON® G1726 by Kraton Corporation.

The hot melt adhesive composition of the present invention also comprises a compatible tackifying resins or tackifiers, which extend adhesive properties and improve specific adhesion. As used herein, the term “tackifier” or “tackifying resin” includes:
(a) aliphatic and cycloaliphatic petroleum hydrocarbon resins having Ring and Ball (R&B) softening points of from 10° C. to 150° C., as determined by ASTM method E28-58T, the latter resins resulting from the polymerization of monomers consisting primarily of aliphatic and/or cycloaliphatic olefins and diolefins; also included are the hydrogenated aliphatic and cycloaliphatic petroleum hydrocarbon resins; examples of such commercially available resins based on a C5 olefin fraction of this type are Piccotac 95 tackifying resin sold by Eastman Chemicals and Escorez 1310LC sold by ExxonMobil Chemical Company and examples of hydrogenated cycloaliphatic petroleum hydrocarbon resins based on cyclopentadiene are Escorez 5400 from Exxonmobil and Resinall R1095S from Resinall Corporation;
(b) aromatic petroleum hydrocarbon resins and the hydrogenated derivatives thereof; an example of hydrogenated aromatic hydrocarbon resin is Arkon P-115 from Arakawa Chemicals;
(c) aliphatic/aromatic petroleum derived hydrocarbon resins and the hydrogenated derivatives thereof;
(d) aromatic modified cycloaliphatic resins and the hydrogenated derivatives thereof;
(e) polyterpene resins having a softening point of from about 10° C. to about 140° C., the latter polyterpene resins generally resulting from the polymerization of terpene hydrocarbons, such as the mono-terpene known as pinene, in the presence of Friedel-Crafts catalysts at moderately low temperatures; also included are the hydrogenated polyterpene resins;
(f) copolymers and terpolymers of natural terpenes, e.g. styrene/terpene, □-ethyl styrene/terpene and vinyl toluene/terpene;
(g) natural and modified rosin such as, for example, gum rosin, wood rosin, tall-oil rosin, distilled rosin, hydrogenated rosin, dimerized rosin and polymerized rosin;
(h) glycerol and pentaerythritol esters of natural and modified rosin, such as, for example, the glycerol ester of pale wood rosin, the glycerol ester of hydrogenated rosin, the glycerol ester of polymerized rosin, the pentaerythritol ester of pale wood rosin, the pentaerythritol ester of hydrogenated rosin, the pentaerythritol ester of tall-oil rosin, and the phenolic modified pentaerythritol ester of rosin; and
(i) phenolic-modified terpene resins such as, for example, the resin product resulting from the condensation in an acidic medium of a terpene and a phenol.

Mixtures of two or more of the above described tackifying resins may be required for some formulations. Tackifying resins which are useful for the present invention can perhaps include polar tackifying resins. However, the choice of available polar tackifying resins is limited in view of the fact that many of the polar resins appear only partially compatible with polyolefins. Preferably, the tackifying resins can be selected from any of the nonpolar types, which are commercially available. Preferred resins for use herein are thermoplastic resins obtained from the copolymerization and hydrogenation of C5 aliphatic olefin and diolefin generated in the thermal cracking process of naphtha. Examples of such resins include the SUKOREZ® line of resins commercially available from Kolon Industries.

The hot melt adhesive composition of the present invention also comprises a plasticizer. A plasticizer serves to provide desired viscosity control and to impart flexibility. A suitable plasticizer may be selected from the group which includes the usual plasticizing oils, such as mineral oil, but also olefin oligomers and low molecular weight polymers, as well as vegetable and animal oils and derivatives thereof. The petroleum derived oils which may be employed are relatively high boiling materials containing only a minor proportion of aromatic hydrocarbons. In this regard, the aromatic hydrocarbons should preferably be less than 30% and more particularly less than 15% of the oil, as measured by the fraction of aromatic carbon atoms. More preferably, the oil may be essentially non-aromatic. The oligomers may be polypropylenes, polybutenes, hydrogenated polyisoprenes, hydrogenated polybutadienes, or the like having average molecular weight between about 350 g/mole and about 10,000 g/mole. Suitable vegetable and animal oils include glycerol esters of the usual fatty acids and polymerization products thereof. Other useful plasticizers can be found in the families of conventional dibenzoate, phosphate, phthalate esters, as well as esters of mono- or polyglycols. Examples of such plasticizers includes, but are not limited to dipropylene glycol dibenzoate, pentaerythritol tetrabenzoate, 2-ethylhexyl diphenyl phosphate, polyethylene glycol 400-di-2-ethylhexoate; butyl benzyl phthalate, dibutyl phthalate and dioctylphthalate. The plasticizers that find usefulness in the present invention can be any number of different plasticizers but the inventors have discovered that mineral oil and liquid polybutenes having average molecular weight less than 5,000 g/mol are particularly advantageous. As will be appreciated, plasticizers have typically been used to lower the viscosity of the overall adhesive composition without substantially decreasing the adhesive strength and/or the service temperature of the adhesive as well as to extend the open time and to improve flexibility of the adhesive. Suitable plasticizers for use herein include the CALSOL line of plasticizers, commercially available from Calumet Specialty Products.

The relative amounts of the constituents of the hot melt adhesive composition of the present invention can vary over a wide range depending on the particular end use and desired properties, such as adhesive properties, application temperature, viscosity at the application temperature, shore A hardness, and perceived softness. In an embodiment of the invention, the first polymer, the second polymer, the wax, the hydrogenated styrene block copolymer, the tackifier, and the plasticizer are present in amounts effective to provide a hot melt adhesive composition having one or both of the following:
a creep resistance of at least 80 initially, after aging for one week, and after aging for two weeks and at least 60 after aging for four weeks; and
a Shore A hardness of at least 80, preferably at least 87.
   As used herein, creep resistance has the meaning as explained in the Examples below.

In an embodiment of the invention, the first polymer, the second polymer, the wax, the hydrogenated styrene block copolymer, the tackifier, and the plasticizer are present in amounts effective to provide a hot melt adhesive composition having one or both of the following:
a softness of at most about 4, preferably at most about 3.5;
a sprayability of at least about 1.5, preferably at least about 2; and
a blocking value of at most about 3, preferably at most about 2.5.
   As used herein, softness and sprayability have the meaning and are determined as explained in the Examples below. Blocking value is a measure of the extent to which an unrolled spool of laminate sticks to itself due to adhesive having bled through its substrate. A value of one means that none of the unrolled spool stuck to itself, whereas a value of five means that there was an extensive amount of the laminate sticking to itself. It has been found that with increasing amount of the wax, although the Shore A hardness values increase, the perceived softness of the cooled adhesive within a laminate also increases, with an increasing amount of wax. Increased Shore A hardness with improving perceived softness is counterintuitive and surprising.

According to another embodiment of the invention, the primary constituents of the hot melt adhesive composition are present, either individually or collectively, in the following amounts:
(a) the first polymer is present in an amount of from about 0.1 to about 20 wt %;
(b) the second polymer is present in an amount of from about 8 to about 40 wt %;
(c) the wax is present in an amount of from at about 2 to about 24 wt %;
(d) the hydrogenated styrene block copolymer is present in an amount of from about 0.25 to about 30 wt %;
(e) the tackifier is present in an amount of from about 35 to about 65 wt %; and
(f) the plasticizer is present in an amount of from about 2 to about 12 wt %.

According to another embodiment of the invention (referred to herein as the “Low SBC Formulation”), the primary constituents of the hot melt adhesive composition are present, either individually or collectively, in the following amounts:
(a) the first polymer is present in an amount of from about 4 to about 20 wt %, preferably from about 5 to about 15 wt %, and most preferably from about 6 to about 10 wt %;
(b) the second polymer is present in an amount of from about 12 to about 40 wt %, preferably from about 15 to about 35 wt %, and most preferably from about 20 to about 30 wt %;
(c) the wax is present in an amount of from at about 4 to about 24 wt %, preferably from about 5 to about 20 wt %, and most preferably from about 7 to about 15 wt %;
(d) the hydrogenated styrene block copolymer is present in an amount of from about 0.25 to about 10 wt %, preferably from about 0.5 to about 5 wt %, and most preferably from about 0.5 to about 2 wt %;
(e) the tackifier is present in an amount of from about 35 to about 65 wt %, preferably from about 40 to about 60 wt %, and most preferably from about 45 to about 55 wt %; and
(f) the plasticizer is present in an amount of from about 2 to about 12 wt %, preferably from about 3 to about 10 wt %, and most preferably from about 4 to about 7 wt %.

According to yet another embodiment of the invention (referred to herein as the “High SBC Formulation”), the primary constituents of the hot melt adhesive composition are present, either individually or collectively, in the following amounts:
(a) the first polymer is present in an amount of from about 0.1 to about 10 wt %, preferably from about 0.2 to about 5 wt %, and most preferably from about 0.25 to about 3 wt %;
(b) the second polymer is present in an amount of from about 8 to about 40 wt %, preferably from about 12 to about 30 wt %, and most preferably from about 15 to about 25 wt %;
(c) the wax is present in an amount of from at about 2 to about 20 wt %, preferably from about 3 to about 15 wt %, and most preferably from about 4 to about 10 wt %;
(d) the hydrogenated styrene block copolymer is present in an amount of from about 10 to about 30 wt %, preferably from about 12 to about 27 wt %, and most preferably from about 15 to about 25 wt %;
(e) the tackifier is present in an amount of from about 35 to about 65 wt %, preferably from about 40 to about 60 wt %, and most preferably from about 45 to about 55 wt %; and
(f) the plasticizer is present in an amount of from about 2 to about 12 wt %, preferably from about 3 to about 10 wt %, and most preferably from about 4 to about 7 wt %.

The amounts of the constituents stated herein are based on the total weight of the hot melt adhesive composition. The composition could be made up solely of (i.e., consist essentially of or consist of) the six primary constituents listed above. Alternatively, the hot melt adhesive composition may include one or more additional, optional constituents. One such optional constituent is a stabilizer. A stabilizer, if present, may be included in an amount of from about 0.1% to about 3% by weight. Preferably from about 0.2% to 1% of a stabilizer is incorporated into the composition. Stabilizers which are useful in the hot melt adhesive compositions of the present invention are incorporated to help protect the polymers noted above, and thereby the total adhesive system, from the effects of thermal and oxidative degradation which normally occurs during the manufacture and application of the adhesive as well as in the ordinary exposure of the final product to the ambient environment. Among the applicable stabilizers are high molecular weight hindered phenols and multifunction phenols, such as sulfur and phosphorous-containing phenols. Hindered phenols are well known to those skilled in the art and may be characterized as phenolic compounds that also contain sterically bulky radicals in close proximity to the phenolic hydroxyl group thereof. In particular, tertiary butyl groups generally are substituted onto the benzene ring in at least one of the ortho positions relative to the phenolic hydroxyl group. The presence of these sterically bulky substituted radicals in the vicinity of the hydroxyl group serves to retard its stretching frequency and correspondingly, its reactivity; this steric hindrance thus providing the phenolic compound with its stabilizing properties.

The performance of these stabilizers may be further enhanced by utilizing, in conjunction therewith; (1) synergists such as, for example, thiodipropionate esters and phosphites; and (2) chelating agents and metal deactivators as, for example, ethylenediaminetetraacetic acid, slats thereof, and disalicylalpropylenediimine.

It should be understood that other optional additives may be incorporated into the hot melt adhesive composition of the present invention in order to modify particular physical properties. These may include, for example, such materials as inert colorants e.g. titanium dioxide, fillers, fluorescent agents, UV absorbers, surfactants, other types of polymers, etc. Typical fillers include talc, calcium carbonate, clay silica, mica, wollastonite, feldspar, aluminum silicate, alumina, hydrated alumina, glass microspheres, ceramic microspheres, thermoplastic microspheres, baryte and wood flour. Surfactants are particularly important in hygienic disposable nonwoven because they can dramatically reduce the surface tension, for example, of the adhesive applied to diaper core, thereby permitting quicker transport and subsequent absorption of urine by the core.

The hot melt composition of the present invention is further characterized by having a low viscosity as measured per ASTM-D3236 by using a Brookfield viscometer at 177° C., of at most about 40,000 cP, preferably at most about 20,000 cP, and most preferably at most about 10,000 cP at 177° C.

The hot melt adhesive composition of the present invention may be formulated by using any of the mixing techniques known in the art. A representative example of the prior art mixing procedure involves placing all the components, except the polymers used in the present invention, in a jacketed mixing kettle equipped with a rotor, and thereafter raising the temperature of the mixture to a range from 150° C. to 200° C. to melt the contents. It should be understood that the precise temperature to be used in this step would depend on the melting points of the particular ingredients. Then the first and second polymers may be subsequently introduced to the kettle under agitation and the mixing is allowed to continue until a consistent and uniform mixture is formed. The content of the kettle is protected with inert gas such as carbon dioxide or nitrogen during the entire mixing process. Without violating the spirit of the present invention, various additions and variation can be made to this procedure to produce the hot melt composition, such as, for example, applying vacuum to facilitate the removal of entrapped air. Other equipment useful for formulating the composition of the present invention includes, but is not limited to, single or twin screw extruders or other variations of extrusion machinery, kneaders, intensive mixers, Ross™ mixers, and the like.

The adhesive composition of the present invention may be used as a general purpose hot melt adhesive in a number of applications such as, for example, in disposable nonwoven hygienic articles, paper converting, flexible packaging, wood working, carton and case sealing, labeling and other assembly applications. Particularly preferred applications include nonwoven disposable diaper and feminine sanitary napkin construction, diaper and adult incontinent brief elastic attachment, diaper and napkin core stabilization, diaper backsheet lamination, industrial filter material conversion, surgical gown and surgical drape assembly, etc.

The resulting hot melt adhesives may be then applied to substrates using a variety application techniques. Examples includes hot melt glue gun, hot melt slot-die coating, hot melt wheel coating, hot melt roller coating, melt blown coating, spiral spray, contact or noncontact strand coatings branded as Omega™, Surewrap™, V-slot™ and Allegro™ methods and the like. In a preferred embodiment, the hot melt adhesive is directly applied onto elastic strands using the strand coating methods, which are preferred techniques for elastic attachment in diaper and adult incontinent article manufacturing. In one example, the hot melt composition of the present invention is coated using an Allegro™ nozzle to form a continuous adhesive bond line on elastic strands used for elasticized legs, leg cuffs, and waistbands on baby diapers, training pants and adult incontinent articles. It is not the intent of this invention to provide a full description of various techniques and the details can be found in the literature or on nozzle manufacturer's websites www.nordson.com or www.itw.com.

In an embodiment of the invention, a method of making a laminate comprises the steps of: (1) applying the hot melt adhesive composition of the invention in a molten state to a primary substrate; and (2) mating a secondary substrate to the first substrate by contacting the secondary substrate with the adhesive composition, wherein at least one of the first substrate or the second substrate is elastic. The primary substrate may be an elastic portion of a diaper, such as an elastic strand used as part of a leg cuff of a diaper or an elastic band used as a back ear laminate of a diaper. Such elastic strands (or bands) and their application as part of a leg cuff of a diaper are shown in U.S. Pat. No. 5,190,606, incorporated herein by reference. The secondary substrate may comprise a nonwoven material, fabric, or a film, such as a spunbond/meltblown/spunbond (SMS) nonwoven fabric or polyethylene film, and the method may include folding the secondary substrate around the elastic strand or wrapping it around the elastic strand. In this way, only the secondary substrate may serve as the substrate which encapsulates the strand or strands of the leg cuff.

In an alternative embodiment, a tertiary substrate is used, and the secondary and tertiary substrates may be mated to the elastic strand on opposite sides of the elastic strand. In such an embodiment, the secondary substrate may be a polyethylene film and the tertiary substrate may be a film of nonwoven material, or verse visa. Furthermore, a composite diaper backsheet consisting of a polyolefin film joined to a nonwoven fabric can also be used as the secondary and tertiary substrates mentioned above.

In other embodiments in which the primary substrate is an elastic strand, the secondary substrate may be a polyethylene film and a tertiary substrate, such as a nonwoven fabric, may be adhered to the film. In embodiments in which the primary substrate is a nonwoven fabric, the secondary substrate may be an elastic film. As shown by the examples below, compositions of the present invention give outstanding results, when applied to an elastic strand, in creep tests which simulate the performance requirements in industry.

A laminate made by any of the methods described herein may be used as an elastic leg cuff, a standing leg cuff, an elastic side panel, or a stretch ear in a disposable article. Such laminates have an elastic substrate and at least one other substrate.

### Aspects of the Invention

Aspect 1. A hot melt adhesive composition comprising:
(a) a first polymer comprising a single-site catalyzed polypropylene co-polymer having a weight average molecular weight from about 10,000 g/mole to about 90,000 g/mole and a melt enthalpy of about 30 J/g to about 100 J/g;
(b) a second polymer comprising a single-site catalyzed polypropylene co-polymer having a weight average molecular weight greater than 100,000 g/mole and a melt enthalpy of about 0 J/g to about 30 J/g;
(c) a wax;
(d) a hydrogenated styrene block copolymer;
(e) a tackifier; and
(f) a plasticizer.
   Aspect 2. The composition of aspect 1 wherein the hydrogenated styrene block copolymer is selected from the group consisting of at least one of SEBS, SEPS, and SEEPS.
   Aspect 3. The composition of aspect 1, wherein the hydrogenated styrene block copolymer comprises SEBS.
   Aspect 4. The composition of aspect 3, wherein the SEBS has from about 50 to about 85%, preferably from about 60 to about 80%, diblock; has from about 15 to about 50%, preferably from about 20 to about 40%, styrene; has a melt flow rate of from about 1 to about 60, preferably from about 2 to about 50, more preferably from about 5 to about 40 g/10 min. tested at 200° C. using a 5 kg weight; and has a Shore A hardness of from about 40 to about 100, preferably from about 50 to about 90, and most preferably from about 55 to about 85.
   Aspect 5. The composition of any of aspects 1-4, wherein:
(a) the first polymer is present in an amount of from about 0.1 to about 20 wt %;
(b) the second polymer is present in an amount of from about 8 to about 40 wt %;
(c) the wax is present in an amount of from at about 2 to about 24 wt %;
(d) the hydrogenated styrene block copolymer is present in an amount of from about 0.25 to about 30 wt %;
(e) the tackifier is present in an amount of from about 35 to about 65 wt %; and
(f) the plasticizer is present in an amount of from about 2 to about 12 wt %.
   Aspect 6. The composition of any of aspects 1-4, wherein:
(a) the first polymer is present in an amount of from about 4 to about 20 wt %, preferably from about 5 to about 15 wt %, and most preferably from about 6 to about 10 wt %;
(b) the second polymer is present in an amount of from about 12 to about 40 wt %, preferably from about 15 to about 35 wt %, and most preferably from about 20 to about 30 wt %;
(c) the wax is present in an amount of from at about 4 to about 24 wt %, preferably from about 5 to about 20 wt %, and most preferably from about 7 to about 15 wt %;
(d) the hydrogenated styrene block copolymer is present in an amount of from about 0.25 to about 10 wt %, preferably from about 0.5 to about 5 wt %, more preferably about 0.5 to 3 wt %, and most preferably from about 0.5 to about 2 wt %;
(e) the tackifier is present in an amount of from about 35 to about 65 wt %, preferably from about 40 to about 60 wt %, and most preferably from about 45 to about 55 wt %; and
(f) the plasticizer is present in an amount of from about 2 to about 12 wt %, preferably from about 3 to about 10 wt %, and most preferably from about 4 to about 7 wt %.
   Aspect 7. The composition of any of aspects 1-4, wherein:
(a) the first polymer is present in an amount of from about 0.1 to about 10 wt %, preferably from about 0.2 to about 5 wt %, and most preferably from about 0.25 to about 3 wt %;
(b) the second polymer is present in an amount of from about 8 to about 40 wt %, preferably from about 12 to about 30 wt %, and most preferably from about 15 to about 25 wt %;
(c) the wax is present in an amount of from at about 2 to about 20 wt %, preferably from about 3 to about 15 wt %, and most preferably from about 4 to about 10 wt %;
(d) the hydrogenated styrene block copolymer is present in an amount of from about 10 to about 30 wt %, preferably from about 12 to about 27 wt %, and most preferably from about 15 to about 25 wt %;
(e) the tackifier is present in an amount of from about 35 to about 65 wt %, preferably from about 40 to about 60 wt %, and most preferably from about 45 to about 55 wt %; and
(f) the plasticizer is present in an amount of from about 2 to about 12 wt %, preferably from about 3 to about 10 wt %, and most preferably from about 4 to about 7 wt %.
   Aspect 8. The composition of any of aspects 1-7, wherein the wax comprises a Fischer-Tropsch wax.
   Aspect 9. The composition of aspect 8, wherein the wax has one or more of the following properties:
(a) a congealing point in accordance with ASTM D938 between about 60 and about 105° C., preferably between about 64° C. and about 102° C., more preferably between about 80° C. and about 102° C., and most preferably between about 80° C. and 86° C.;
(b) a percentage of isoalkanes between about 2.5% and 20%, preferably between about 5 and 15%, most preferably between about 10% and 15%;
(c) a Brookfield viscosity at 135° C. of below 20 mPa-s;
(d) a penetration at 25° C. of below 10 1/10 mm, and preferably below 8 1/10 mm;
(e) a heat of fusion provided in accordance with ASTM E 793 between about 180 J/g and 230 J/g, preferably between about 205 J/g and about 230 J/g, most preferably between about 215 J/g and about 225 J/g;
(f) an oil content below 1 wt.-%; and
(g) a molecular mass (number average) between 500 and 1200 grams per mole, more preferred between 575 and 950 grams per mole.
   Aspect 10. The composition of any of aspects 1-9, wherein the weight average molecular weight of the second polymer is at least double, preferably at least three times, the weight average molecular weight of the first polymer, and the melt enthalpy of the first polymer is at least 20 J/g, preferably at least 35 J/g, and most preferably at least 50 J/g greater than the melt enthalpy of the second polymer.
   Aspect 11. The composition of any of aspects 1-10, wherein the first polymer, the second polymer, the wax, the hydrogenated styrene block copolymer, the tackifier, and the plasticizer are present in amounts effective to provide a hot melt adhesive composition having:
a creep resistance of at least 80 initially, after aging for one week, and after aging for two weeks and at least 60 after aging for four weeks; and
a Shore A hardness of at least 80, preferably at least 87.
   Aspect 12. The composition of any of aspects 1-11, wherein the first polymer, the second polymer, the wax, the hydrogenated styrene block copolymer, the tackifier, and the plasticizer are present in amounts effective to provide:
a softness of at most about 4, preferably at most about 3.5;
a sprayability of at least about 1.5, preferably at least about 2; and
a blocking value of at most about 3, preferably at most about 2.5.
   Aspect 13. The composition of any of Aspects 1-12, wherein hot melt adhesive has a viscosity as measured by ASTM D3236-88 at most about 40,000 cP, preferably at most about 20,000 cP, and most preferably at most about 10,000 cP at 177° C.
   Aspect 14. A method of making a laminate comprising the steps of:
applying the hot melt adhesive composition of any of aspects 1-13 in a molten state to a primary substrate; and
mating a secondary substrate to the first substrate by contacting the secondary substrate with the adhesive composition, wherein at least one of the first substrate or the second substrate is elastic.
   Aspect 15. The method of aspect 14, wherein the primary substrate is an elastic strand.
   Aspect 16. The method of aspect 14, wherein the primary substrate is a nonwoven fabric.
   Aspect 17. The method of aspect 15, wherein the secondary substrate is a nonwoven fabric wrapped around the elastic strand
   Aspect 18. The method of aspect 15, wherein the secondary substrate is a polyethylene film and a tertiary substrate is a nonwoven fabric.
   Aspect 19. A laminate made by the method of any of aspects 14-18 used as an elastic leg cuff, a standing leg cuff, an elastic side panel, or a stretch ear in a disposable article.

### Examples

The invention is further illustrated by way of the examples which are set forth below.

Brookfield viscosity is provided herein according to ASTM D-3236 Method at 163° C. (325° F.).

The Differential Scanning Calorimetry (DSC) test was run with a heat-quench-heat program on a DSC Model Q 1000 from TA Instrument. Preferably, a sample of about 10 mg in size was sealed in an aluminum DSC sample pan. The pan was placed in the instrument sample chamber and heated at 20° C./min heating rate from the ambient temperature to 200° C., from which the sample was quickly quenched to −110° C. The temperature was then ramped up to 200° C. at the 20° C./min heating rate and the data is collected. The enthalpy of melting (ΔH) measured in Joules per gram (J/g) is calculated from the area of the melting peak on the DSC curve using the application software package installed in Model Q 1000 DSC. For the purpose of the present invention except where specified otherwise, the melting point is defined as the temperature corresponding to the melting peak maximum, i.e., the highest point on the melting peak.

Specimens for creep test were prepared using a customized coater/laminator equipped with a Nordson™ mZero-Cavity hot melt coating module which is designed to accommodate Surewrap™, Allegro™ and slot die tips. For the present invention, an Allegro tip is used to apply the present composition directly to Invista™ elastic strands having 680 Decitex (dtex) fineness. The tip has three separate adhesive nozzles or orifices of 5 mm apart capable of coating three elastic strands simultaneously. Specimens for the Creep Retention test were prepared by using Allegro™ single strand coating technique on a customized hot melt coater which is equipped with a Nordson Zero Cavity™ coating module fitted with an Allegro™ nozzle. Three elastic strands (Investa 680), stretched to 300% elongation, were each individually coated at about 150° C. coating temperature. In these coating trials, the elastic strand entrance angle to the nozzle guide (i.e., the angle between a line normal to the axis of the applicator and the elastic strand extending between the nozzle and the guide or roller closest to the nozzle on the inlet side) was kept at 2.5°. (Note the parameters described above are described using conventions employed by nozzle manufacturer in, “Universal Allegro Elastic Coating Nozzles Customer Product Manual, Part 1120705_01” Issued February 2015). The adhesives were applied at about 300 meter/minute line speed, 25 milligrams per strand per meter (mg/s/m) add-on, 0.5 seconds open time and 40 psi compression at the nip rolls. The coated strands are then laminated between a polyethylene film (Clopay DH284 PE) and a polypropylene spunbond nonwovens fabric (NW FQN 12 gsm) to form an elastic laminate.

Creep Resistance test was carried out with laminated specimens as described in Examples 1 and 2. The laminated specimens comprise an elastic strand and non-elastic substrates. A segment of the laminated specimen about 350 mm is stretched completely and is securely attached to a piece of rigid Polyglass board. A length of 300 mm is marked and the elastic strands are cut at the marks while the non-elastic substrates are maintained in the stretched configuration. The specimen is then placed in an air-circulating oven at 37.8° C. (100° F.). Under these conditions, the elastic strands under stretch can retract to a certain distance. The distance between the ends of the elastic strands is measured after four hours. The ratio of the final length to the initial length, defined as Creep Retention and expressed in percentage (%), is a measure of the ability of the adhesive to hold the elastic strands.

### Materials:

Calsol 5550 is a naphthenic process oil commercially available from Calumet Specialty Products.

Sukorez SU-500, commercially available from Kolon USA Inc, is a hydrogenated DCPD tackifier having an R&B softening point of about 100° C.

Irganox 1010 is a hindered phenol antioxidant commercially available from BASF Corporation.

Seration 1830 is a Fischer-Tropsch wax having a congealing point of about 83° C., commercially available from Sasol Ltd.

Licocene PP2502, commercially available from Clariant, is polypropylene co-polymer having a weight average molecular weight (Mw) of about 18,000 g/mol and a heat of fusion of about 37 J/g.

Vistamaxx 6502, commercially available from Exxonmobil Chemical Company, is a polypropylene copolymer having a weight average molecular weight (Mw) of about 119,000 g/mol and a heat of fusion of about 9 J/g.

Kraton G1726M, commercially available from Kraton Corporation, is an SEBS copolymer having a styrene content of 30 wt % and a diblock content of 70 wt %.

The hot melt adhesives of examples 1 and 2 shown by weight percent in Table 1 were prepared with the ingredients and mixing procedures described herein above. The mixing was carried out at 177° C. under nitrogen atmosphere in a laboratory type of mixer that consists of a propeller powered by a motor, a heating mantle, a temperature control unit, and a container of about 1 gallon in size. The appropriate amounts of each component, calculated according to the ratios shown in the table, except the polymers, were added to the container. The temperature of the container was then raised to melt the content. After the ingredients in the container were completely melted, the motor is turned on to start agitation. The polymer components were then introduced. Mixing was continued until the polymers were completely dissolved and a uniform mixture is formed.

TABLE 1

| Raw Material | Ex. 1 | Ex. 2 |
|---|---|---|
| Calsol 5550 | 5.48 | 5.00 |
| Sukorez SU-500 | 47.78 | 47.81 |
| Irganox 1010 | 0.50 | 0.50 |
| Seration 1830 | 11.70 | 6.57 |
| Licocene PP2502 | 8.54 | 0.52 |
| Vistamaxx 6502 | 25.00 | 20.21 |
| Kraton G1726M | 1.00 | 19.39 |
| Total | 100 | 100 |
| SP (° C.) - Glycerin | 85 | 99 |
| 163° C. (cP) | 9,875 | 12,320 |
| 177° C. (cP) | 6,550 | 6,987 |

The Ring and Ball softening point (“SP” in Table 1) was measured by ASTM E28 in glycerol with an automated Herzog unit.

The following tests were carried out on Examples 1 and 2 as well as a PO-based adhesive, H9696U, commercially-available from Bostik, Inc., and are reported below in Tables 2 and 3: Creep retention, a softness test, and a sprayability test.

The softness test averaged five different parameters: hand friction, roughness, fuzziness, even weight hand feel, and skewed hand feel, with each parameter rated on a scale of 1 to 5, with 1 being the most soft and 5 being the least soft. Hand friction is the force required to move the hand across the surface of the laminate where the adhesive had been deposited, with no drag contributing to a lower number and high resistance (or drag) contributing a higher number. Roughness is the overall presence of gritty, grainy, or lumpy particles on the laminate surface where the adhesive had been deposited, with no such particles contributing to a lower number and many such particles contributing to a higher number. Fuzziness is the amount of pile, fiber, or fuzz on the laminate surface where the adhesive had been deposited, with no such pile, fiber, or fuzz contributing to a lower number and vice versa. Hand feel is merely an overall subjective measure of how soft the laminate feels to someone touching the laminate where the adhesive had been deposited, and is counted twice in developing the overall softness average, once as the mean (referred to as ‘Even Weight’ in Table 3) and once as the median (referred to as ‘Skewed’ in Table 3).

The sprayability test is observational-based for a spray nozzle that was not a spiral spray nozzle. Two criteria were observed: (1) the uniformity of each interval of adhesive deposited onto the strand; and (2) the amount of adhesive which was deposited on the strand relative to the overall amount of adhesive sprayed. For the former, small deviations in length or width of adjacent deposited intervals of adhesive contributed to a better sprayability, meaning a higher number in the 1 to 5 scale. Conversely, large deviations in length or width of adjacent deposited intervals of adhesive contributed to poor sprayability, meaning a lower number in the 1 to 5 scale. For the second criteria, a higher amount of adhesive which was deposited on the strand relative to the overall amount of adhesive sprayed leads to better sprayability (and better creep retention) and therefore a higher sprayability number, and vice versa.

TABLE 2

| | | | H9696U | Example 1 | Example 2 |
|---|---|---|---|---|---|
| Sprayability (0-5, none to excellent) | | | 3 | 3 | 2 |
| % Creep Retentio [symbol] | Condition 1 | Initial | 97 | 93 | 30 |
| | | 1 Week Aged | 97 | 84 | Not tested due |
| | | 2 Week Aged | 97 | 85 | to complete |
| | | 4 Week Aged | 94 | 69 | failure initially |
| | Condition 2 | Initial | 95 | 93 | 36 |
| | | 1 Week Aged | 96 | 88 | Not tested due |
| | | 2 Week Aged | 95 | 88 | to complete |
| | | 4 Week Aged | 95 | 70 | failure initially |
| | Primary Substrat [symbol] | Secondayr Substrat [symbol] | App. Method | Add-on | Open Time (se [symbol] |
| Condition 1 | PE | NW | Allegro | 25 mg/m/s | 0.1 |
| Condition 2 | PE | NW | Allegro | 25 mg/m/s | 0.5 |

[symbol]

indicates data missing or illegible when filed

Example 1 demonstrated sprayability and creep retention comparable to the control.

TABLE 3

| | Hand | | | Even | | | |
|---|---|---|---|---|---|---|---|
| | Friction | Roughness | Fuzziness | Weight | Skewed | | Overall |
| | (ave.) | (ave.) | (ave.) | HF (ave.) | HF (ave.) | Total | Average |
| H9696U | 3.50 | 3.75 | 3.65 | 3.64 | 3.65 | 18.19 | 3.64 |
| Example 2 | 2.83 | 2.66 | 3.03 | 2.84 | 2.80 | 14.16 | 2.83 |
| Example 1 | 2.77 | 2.63 | 2.91 | 2.75 | 2.72 | 13.78 | 2.76 |

Both Examples 1 and 2 demonstrated softness better than the control.

Where a range of values is provided, it is understood that each intervening value, and any combination or sub-combination of intervening values, between the upper and lower limit of that range and any other stated or intervening value in that stated range, is encompassed within the range of values recited. In addition, the invention includes a range of a constituent which is the lower limit of a first range and an upper limit of a second range of that constituent.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue or prior invention.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

1. A hot melt adhesive composition comprising:
(a) a first polymer comprising a single-site catalyzed polypropylene co-polymer having a weight average molecular weight from about 10,000 g/mole to about 90,000 g/mole and a melt enthalpy of about 30 J/g to about 100 J/g;
(b) a second polymer comprising a single-site catalyzed polypropylene co-polymer having a weight average molecular weight greater than 100,000 g/mole and a melt enthalpy of about 0 J/g to about 30 J/g;
(c) a wax;
(d) a hydrogenated styrene block copolymer;
(e) a tackifier; and
(f) a plasticizer.

2. The composition of claim 1 wherein the hydrogenated styrene block copolymer is selected from the group consisting of at least one of SEBS, SEPS, and SEEPS.

3. The composition of claim 1, wherein the hydrogenated styrene block copolymer comprises SEBS.

4. The composition of claim 3, wherein the SEBS has from about 50 to about 85% diblock; has from about 15 to about 50% styrene; has a melt flow rate of from about 1 to about 60 g/10 min. tested at 200° C. using a 5 kg weight; and has a Shore A hardness of from about 40 to about 100.

5. The composition of claim 1, wherein:
(a) the first polymer is present in an amount of from about 4 to about 20 wt %;
(b) the second polymer is present in an amount of from about 12 to about 40 wt %;
(c) the wax is present in an amount of from at about 4 to about 24 wt %;
(d) the hydrogenated styrene block copolymer is present in an amount of from about 0.25 to about 10 wt %;
(e) the tackifier is present in an amount of from about 35 to about 65 wt %; and
(f) the plasticizer is present in an amount of from about 2 to about 12 wt %.

6. The composition of claim 1, wherein the wax comprises a Fischer-Tropsch wax.

7. The composition of claim 1, wherein the weight average molecular weight of the second polymer is at least double the weight average molecular weight of the first polymer, and the melt enthalpy of the first polymer is at least 20 J/g greater than the melt enthalpy of the second polymer.

8. The composition of claim 1, wherein the first polymer, the second polymer, the wax, the hydrogenated styrene block copolymer, the tackifier, and the plasticizer are present in amounts effective to provide a hot melt adhesive composition having:
a creep resistance of at least 80 initially, after aging for one week, and after aging for two weeks and at least 60 after aging for four weeks; and
a Shore A hardness of at least 80.

9. The composition of claim 1, wherein the first polymer, the second polymer, the wax, the hydrogenated styrene block copolymer, the tackifier, and the plasticizer are present in amounts effective to provide:
a softness of at most about 4;
a sprayability of at least about 1.5; and
a blocking value of at most about 3.

10. The composition of claim 1, wherein hot melt adhesive has a viscosity as measured by ASTM D3236-88 at most about 40,000 cP at 177° C.

11. A method of making a laminate comprising the steps of:
applying the hot melt adhesive composition of claim 1 in a molten state to a primary substrate; and mating a secondary substrate to the first substrate by contacting the secondary substrate with the adhesive composition, wherein at least one of the first substrate or the second substrate is elastic.

12. The method of claim 11, wherein the primary substrate is an elastic strand.

13. The method of claim 11, wherein the primary substrate is a nonwoven fabric.

14. The method of claim 12, wherein the secondary substrate is a nonwoven fabric wrapped around the elastic strand

15. The method of claim 12, wherein the secondary substrate is a polyethylene film and a tertiary substrate is a nonwoven fabric.

16. A laminate made by the method of claim 11 used as an elastic leg cuff, a standing leg cuff, an elastic side panel, or a stretch ear in a disposable article.
